(19) United States
(12) Patent Application Publication
(10) Pub. No.: US 2023/0141278 A1
(43) Pub. Date: May 11, 2023

(54) METHOD AND DEVICE FOR PIERCING A WORKPIECE BY MEANS OF A LASER BEAM

(71) Applicant: Precitec GmbH & Co. KG, Gaggenau (DE)

(72) Inventors: Niklas Weckenmann, Rastatt (DE); Jannik Lind, Stuttgart (DE)

(21) Appl. No.: 17/910,948

(22) PCT Filed: Mar. 9, 2021
(86) PCT No.: PCT/EP2021/055900

§ 371 Date: Sep. 12, 2022

(30) Foreign Application Priority Data
Mar. 12, 2020 (DE) 10 2020 106 734.8

(51) Int. Cl. B23K 26/0622; B23K 26/382

(52) U.S. Cl. CPC B23K 26/0622; B23K 26/382

(57) ABSTRACT

A method for piercing a workpiece by means of a laser beam includes radiating a pulsed laser beam onto a workpiece to form a piercing breakthrough, wherein a radiated mean pulse power (Pₘᵢₜₜₑₗ) of the pulsed laser beam is reduced during piercing.

### CROSS-REFERENCE TO RELATED APPLICATIONS

This application is the U.S. National Stage of PCT/EP2021/055900 filed on Mar. 9, 2021, which claims priority to German Patent Application 102020106734.8 filed on Mar. 12, 2020, the entire content of both are incorporated herein by reference in their entirety.

### FIELD OF THE INVENTION

The present disclosure relates to a method and a device for piercing a workpiece by means of a laser beam and in particular to a method and a device for controlling a piercing process in laser material machining.

### BACKGROUND OF THE INVENTION

In a device for material machining using a laser, e.g. in a laser machining head for laser cutting, the laser beam emerging from a laser light source or one end of a laser optical fiber is focused or collimated on the workpiece to be machined by means of beam guiding and focusing optics. Typically, a laser machining head with collimation optics and focusing optics is used, with the laser light being supplied via an optical fiber, also referred to as a laser source.

Within the framework of laser material machining, in particular within the framework of laser cutting, a piercing process may be carried out on the workpiece by means of the laser beam. The piercing process takes place prior to the actual cutting process in laser cutting. In this process, an initial hole or puncture which serves as the starting point for the cutting process is created in the workpiece. The piercing process or piercing into the workpiece may therefore also be referred to as a penetrating process or penetrating through the workpiece. Since, for example, a subsequent laser cutting process cannot be started without piercing, successfully piercing through the workpiece plays an important role for laser cutting. The duration, quality and stability of the piercing process depend on a variety of process parameters. Above all, the duration of the piercing process, i.e. the time between the activation of the machining beam and the piercing breakthrough through the material or workpiece (also called breakthrough time or piercing duration), is a critical factor for the efficiency of the machining process. The duration of the piercing process depends on the rate of change of the piercing depth over time. The rate of change of the piercing depth over time is referred to as the piercing rate below and also reflects the process efficiency.

The prior art describes different piercing methods wherein the pulse frequency or the mean laser power within a piercing process is increased up to the piercing breakthrough in order to minimize the piercing duration or the breakthrough time for a given material thickness. U.S. Pat. No. 5,434,383 A describes a piercing method with shortened duration wherein the pulse frequency and relative pulse duty cycle are increased step by step during piercing. DE 11 2009 001 200 B4 also describes a laser machining method for piercing and subsequent cutting, starting with a first frequency for piercing and continuing with piercing at a second frequency greater than the first frequency. In U.S. Pat. No. 6,693,256 B2, on the other hand, the maximum laser power is increased step by step during piercing.

Trends towards higher laser power and greater sheet thicknesses or workpiece thicknesses make the piercing process more difficult and not only result in longer breakthrough times, but also more often in a piercing stop where the piercing rate approaches zero and, therefore, no piercing is possible.

### SUMMARY OF THE INVENTION

It is an object of the present invention to provide a method and a device for piercing a workpiece by means of a laser beam (also called machining beam), by means of which a piercing process can be optimized, in particular for piercing thicker material or thick workpieces, for example with a thickness greater than 10 mm or even greater than 20 mm.

It is a further object of the present invention to provide a method and a device for piercing a workpiece by means of a laser beam, by means of which a piercing duration can be minimized or a piercing rate can be maximized.

It is a further object of the present invention to provide a method and a device for piercing a workpiece by means of a laser beam, by means of which reliable piercing can be ensured and a piercing stop can be prevented.

These objects are achieved by the features described herein. Features of preferred embodiments are described herein.

The present invention is based on the finding that a piercing process can be optimized by a targeted or controlled energy input of the laser beam into the machining zone, and in particular by the targeted or controlled reduction of a mean pulse power of the laser beam radiated into the machining zone during the piercing process. The energy input may be controlled as a function of at least one of the following process parameters and boundary conditions: material thickness, material type, instantaneous or current piercing time, instantaneous or current piercing depth, process gas type, process gas pressure, focal position, image scale of the optical system, nozzle type, nozzle diameter, intensity distribution of the laser beam, focus diameter and nozzle distance to the top of the workpiece. Based on the parameters mentioned, the energy input in the piercing hole or in the machining zone can be adjusted by the pulse on-time, pulse off-time and/or the pulse peak power depending on the current piercing time and/or piercing depth.

According to one aspect, a method for piercing a workpiece by means of a laser beam (also referred to as a machining beam) is specified. The method comprises: radiating a pulsed laser beam onto a workpiece to form a piercing breakthrough, wherein a radiated mean pulse power of the pulsed laser beam is reduced during the piercing or during a breakthrough time, e.g. at least once. The breakthrough time may refer to the duration of the piercing or the piercing process, i.e. a period of time from turning on or radiating the laser beam for the first time to a breakthrough though the workpiece. In other words, a method for piercing a workpiece by means of a pulsed laser beam comprises: a first piercing step, in which a pulsed laser beam with a first mean pulse power is directed or radiated onto a workpiece; and a second piercing step, in which the pulsed laser beam is directed or radiated onto the workpiece with a second mean pulse power, said first mean pulse power being greater than said second mean pulse power. The radiated mean pulse power is preferably reduced at least once during the piercing or during the breakthrough time. The radiated mean pulse power may be reduced discretely, i.e. in steps, or continuously, or in any combination of discrete and continuous changes. The radiated mean pulse power may be reduced several times during piercing or during the breakthrough time. Thus, more than two piercing steps may be carried out, each with different mean pulse powers, which are each lower than a mean pulse power in a preceding piercing step. The radiated mean pulse power may be constant during a piercing step. The radiated mean pulse power of the pulsed laser beam may be reduced monotonically or strictly monotonically during piercing. The radiated mean pulse power of the pulsed laser beam at the beginning of piercing or the piercing time may be greater than the radiated mean pulse power at breakthrough, i.e. at the end of piercing or the breakthrough time. A line of best fit or regression for the radiated mean pulse power preferably has a negative gradient during the breakthrough time, i.e. from the start of piercing to breakthrough. The radiated mean pulse power of the pulsed laser beam may be reduced by at least one of the following settings or changes: lengthening a pulse off-time, reducing a pulse peak power, shortening a pulse on-time, reducing a pulse frequency, and reducing a relative pulse duty cycle. In particular, the radiated mean pulse power may be reduced by varying the pulse on-time and the pulse off-time: For example, the pulse off-time and the pulse on-time may be lengthened when the pulse on-time is lengthened less than the pulse off-time. In another example, the pulse off-time and the pulse on-time may be shortened when the pulse on-time is shortened more than the pulse off-time. In another example, the pulse off-time may remain constant when the pulse on-time is shortened. When the radiated mean pulse power is reduced by lengthening the pulse off-time, the pulse peak power and/or pulse on-time and/or pulse-energy may be kept constant during the piercing or during the breakthrough time. In one embodiment, the method may have at least two piercing steps, the first mean pulse power in the first piercing step being greater than or equal to a mean limit pulse power and the second mean pulse power in the second piercing step being less than the first mean pulse power and/or than the mean limit pulse power. Optionally, the method may comprise a third piercing step in which a third mean pulse power is less than the second mean pulse power. The mean limit pulse power may refer to a mean pulse power from which on the piercing rate approaches zero or from which on a piercing stop occurs or from which on saturation during piercing occurs. The mean limit pulse power may be predetermined as a function of a material and/or a thickness of the workpiece.

According to a further aspect, a method for piercing a workpiece by means of a laser beam (also referred to as a machining beam) is provided. The method comprises: radiating a pulsed laser beam onto a workpiece to form a piercing breakthrough, wherein a pulse off-time of the pulsed laser beam is lengthened during piercing or during a breakthrough time, e.g. at least once. The breakthrough time may refer to the duration of the piercing or the piercing process, i.e. a period of time from when the laser beam is first turned on until breakthrough through the workpiece. In other words, a method for piercing a workpiece by means of a pulsed laser beam comprises: a first piercing step in which a pulsed laser beam with a first pulse off-time is directed or radiated onto a workpiece; and a second piercing step in which the pulsed laser beam with a second pulse off-time is directed onto the workpiece, the first pulse off-time being smaller than the second pulse off-time. The pulse off-time is preferably lengthened at least once during the piercing or during the breakthrough time. The pulse off-time of the pulsed laser beam may be lengthened discretely, i.e. step by step, or continuously, or also in any combination of discrete and continuous changes. The pulse off-time may be reduced several times during piercing or during the breakthrough time. Thus, more than two piercing steps may be performed, each with different pulse off-times, which are each longer than a pulse off-time in a previous piercing step. The pulse off-time may be constant during a piercing step. The pulse off-time may be increased monotonically or strictly monotonically during piercing. The pulse off-time of the pulsed laser beam at the start of the piercing or the breakthrough time may be less than the pulse off-time at breakthrough, i.e. at the end of the piercing or the breakthrough time. A line of best fit or regression for the pulse off-time during the breakthrough time, i.e. from the start of piercing to breakthrough, preferably has a positive slope. The pulse off-time of the pulsed laser beam may be lengthened by reducing a pulse frequency and/or reducing a relative pulse duty cycle. A pulse peak power and/or pulse on-time and/or pulse energy may be kept constant during piercing or during the breakthrough time. In one embodiment, the method may include at least two piercing steps, with the first pulse off-time in the first piercing step being less than or equal to a limit pulse off-time and the second pulse off-time in the second piercing step being greater than the first pulse off-time and/or the limit pulse off-time. Optionally, the method may include a third piercing step in which a third pulse off-time is greater than the second pulse off-time. The limit pulse off-time may refer to a pulse off-time below which the piercing rate approaches zero or a piercing stop occurs or saturation during piercing occurs. The limit pulse off-time may be predetermined as a function of a material and/or a thickness of the workpiece.

According to another further aspect, a method for piercing a workpiece by means of a laser beam (also called machining beam) is provided. The method comprises: radiating a pulsed laser beam onto a workpiece to form a piercing breakthrough, wherein a pulse frequency of the pulsed laser beam is reduced during piercing or during a breakthrough time, e.g. at least once. The breakthrough time may refer to the duration of the piercing or the piercing process, i.e. a period of time from when the laser beam is first turned on until breakthrough through the workpiece. In other words, a method for piercing a workpiece by means of a pulsed laser beam comprises: a first piercing step in which a pulsed laser beam with a first pulse frequency is directed or radiated onto a workpiece; and a second piercing step in which the pulsed laser beam with a second pulse frequency is directed onto the workpiece, the first pulse frequency being greater than the second pulse frequency. The pulse frequency is preferably reduced at least once during piercing or during the breakthrough time. The pulse frequency of the pulsed laser beam may be increased discretely, i.e. step by step, or continuously, or also in any combination of discrete and continuous changes. The pulse frequency may be reduced several times during piercing or during the breakthrough time. Thus, more than two piercing steps may be carried out, each with different pulse frequencies, each of which is lower than a pulse frequency in a preceding piercing step. The pulse frequency may be constant during a piercing step. The pulse frequency may be reduced monotonically or strictly monotonically during piercing. The pulse frequency of the pulsed laser beam at the start of piercing or the breakthrough time may be greater than the pulse frequency at breakthrough, i.e. at the end of piercing or the breakthrough time. A line of best fit or regression for the pulse frequency during the breakthrough time, i.e. from the start of piercing to breakthrough, preferably has a negative slope. The pulse frequency of the pulsed laser beam may be reduced by lengthening a pulse off-time. A pulse peak power and/or pulse on-time and/or pulse energy may be kept constant during piercing or during the breakthrough time. In one embodiment, the method may include at least two piercing steps, with the first pulse frequency in the first piercing step being greater than or equal to a limit pulse frequency and the second pulse frequency in the second piercing step being less than the first pulse frequency and/or the limit pulse frequency. Optionally, the method may include a third piercing step in which a third pulse frequency is less than the second pulse frequency. The limit pulse frequency may refer to a pulse frequency from which on the piercing rate approaches zero or from which on piercing stops or from which on saturation during piercing occurs. The limit pulse frequency may be predetermined as a function of a material and/or a thickness of the workpiece.

Each of these aspects may have one or more of the following characteristics:

Pulse parameters can include the radiated mean pulse power, the pulse off-time, the pulse on-time, the pulse frequency, the pulse period, the relative pulse duty cycle and/or the pulse peak power. At least one of the pulse parameters, selected from the group comprising the radiated mean pulse power, the pulse off-time, the pulse on-time, the pulse frequency, the relative pulse duty cycle and the pulse peak power, may be adjusted based on on a material and/or a thickness of the workpiece (also called material thickness) and/or on a current piercing time and/or on a current piercing depth. In particular, a first pulse frequency, a first mean pulse power and/or a first pulse off-time may be selected depending on the material and/or the thickness of the workpiece. A pulse frequency, a mean pulse power and/or a pulse off-time, in particular in a piercing step following the first piercing step, may be adjusted as a function of a current piercing time and/or a current piercing depth. In particular, at least one of the pulse parameters, selected from the group comprising the radiated mean pulse power, the pulse off-time, the pulse on-time, the pulse frequency, the relative pulse duty cycle and the pulse peak power, may be changed based on at least one of the thickness of the workpiece, the material of the workpiece, a type of process gas, a process gas pressure, a focal position, an imaging ratio of the optical system or the laser machining head, a focus diameter and a nozzle distance from the top of the workpiece, and as a function of the current piercing time and/or piercing depth.

The pulse on-time is preferably constant during piercing or during the breakthrough time. The pulse on-time may be adjusted based on a material or a thickness of the workpiece.

The pulse peak power is preferably constant during piercing or during the breakthrough time. The pulse peak power may be adjusted based on a material or a thickness of the workpiece.

A pulse energy is preferably constant during piercing or during the breakthrough time. In other words, the product of pulse peak power and pulse on-time may be set to be constant. The pulse energy may be adjusted based on a material or a thickness of the workpiece. Optionally, a minimum value for the pulse energy may be adjusted based on a material or a thickness of the workpiece.

Preferably, the duration of the individual piercing steps has different lengths. For example, a duration of a first piercing step may be longer than that of a subsequent, e.g., second or third, piercing step. Moreover, in the case of a discrete or stepwise change in the mean pulse power, the pulse off-time and/or the pulse frequency, a first change, i.e. a change from the first to the second piercing step, may be greater than a second change, i.e. a change from the second piercing step to a third piercing step.

In one embodiment, a pulse frequency used at the start of piercing and/or in the first piercing step may be greater than or equal to a limit pulse frequency. The limit pulse frequency may be predetermined based on the material and/or the thickness of the workpiece.

In one embodiment, a pulse off-time used at the start of piercing and/or in the first piercing step may be greater than or equal to a limit pulse off-time. The limit pulse off-time may be predetermined depending on the material and/or the thickness of the workpiece.

The pulse on-time, e.g. during the breakthrough duration, is preferably in a range between 0.01 ms and 100 ms (0.01 ms≤tₐₙ≤100 ms), in particular between 0.1 ms and 10 ms (0.1 ms≤tₐₙ≤10 ms). The pulse off-time, e.g. during the breakthrough duration, is preferably in a range between 0.01 ms and 100 ms (0.01 ms≤tₐᵤₛ≤100 ms), in particular between 0.1 ms and 10 ms (0.1 ms≤tₐᵤₛ≤10 ms).

Preferably, a pulse on-time or a pulse period of the pulsed laser beam, e.g., during the breakthrough duration, is in the range of microseconds or milliseconds. In this case, piercing may be achieved primarily by melting the workpiece. A fiber, disk or direct diode laser may be used. A wavelength of the pulsed laser beam is preferably in the range of 800 nm to 1300 nm.

The pulse frequency is preferably adjusted based on the thickness of the workpiece. With a workpiece thickness of 10 mm to 15 mm, the pulse frequency, e.g. during the breakthrough duration, may be in a range between 400 Hz and 3000 Hz (400 Hz≤f≤3000 Hz), in particular between 600 Hz and 1500 Hz (600 Hz≤f≤1500 Hz). Here the pulse frequency may be changed at least once during piercing. When the workpiece is thicker than 15 mm to 20 mm, the pulse frequency, e.g. during the breakthrough duration, may be in a range between 300 Hz and 2000 Hz (300 Hz≤f≤2000 Hz), in particular between 400 Hz and 900 Hz (400 Hz≤f≤900 Hz). Here the pulse frequency may be changed at least once during piercing. When the workpiece is thicker than 20 mm to 25 mm, the pulse frequency, e.g. during the breakthrough duration, may be in a range between 300 Hz and 1500 Hz (300 Hz≤f≤1500 Hz), in particular between 400 Hz and 800 Hz (400 Hz≤f≤800 Hz). Here the pulse frequency may be changed at least twice during piercing. When the workpiece is thicker than 25 mm, the pulse frequency, e.g. during the breakthrough duration, may be in a range between 200 Hz and 1000 Hz (200 Hz≤f≤1000 Hz), in particular between 400 Hz and 700 Hz (400 Hz≤f≤700 Hz). Here the pulse frequency may be changed at least twice during piercing.

The method may be used for piercing workpieces with a thickness of at least 10 mm, in particular with a thickness of at least 20 mm, for example with a thickness of 30 mm. A pulse peak power of the pulsed laser beam during piercing is preferably at least 4 kW and may in particular be greater than or equal to 6 kW.

The material can be a metallic workpiece. The workpiece may be made of metal or may include metal. The workpiece may comprise or be a metal sheet. Furthermore, a material of the workpiece or sheet metal may comprise or be at least one of a mild steel alloy, a stainless steel alloy, an aluminum alloy, a copper alloy, a brass alloy, mild steel, stainless steel, aluminum, copper and brass.

An inert process gas, e.g. nitrogen, argon or the like, is preferably directed at the workpiece during piercing. The process gas may hit the workpiece coaxially to the laser beam.

The method for piercing may be used for preparation of a laser cutting process. In other words, the method may further comprise: cutting the work piece by means of the laser, starting from the piercing breakthrough. Hence, according to an embodiment of the present invention, a method for laser cutting is further provided, comprising the method for piercing according to one of the embodiments described in this disclosure; and cutting by means of the laser beam, starting from the piercing breakthrough. During the (entire) method for piercing or during the (entire) piercing, the laser beam (also called machining beam) may be pulsed. During laser cutting, the laser beam is preferably used continuously. Of course, the same laser beam may be used for laser cutting and piercing, possibly with different parameters. In other words, the laser beam for piercing and the laser beam for laser cutting may come from the same laser source.

According to a further aspect, a device for laser material machining of a workpiece is provided. The device comprises a laser source for generating a laser beam; a laser machining head for radiating the laser beam onto a workpiece; and a control device configured to control the device, in particular the laser source and/or the laser machining head, in order to carry out a method for piercing according to one of the embodiments described herein.

Within the scope of this disclosure, the pulse off-time may be defined as the time of a pulse period in which the radiated power is below a predetermined threshold value, for example below 30% or 20% or 10% of a maximum laser power or a pulse peak power. In other words, within the scope of this disclosure, the pulse on-time may be defined as the time of a pulse period in which the radiated power is above a predetermined threshold value, for example above 30%, or 20%, or 10% of a maximum laser power or a pulse peak power.

Furthermore, within the scope of this disclosure, a pulse parameter, for example the radiated mean pulse power, a pulse peak power, a pulse frequency, a pulse period, a pulse off-time, a pulse on-time, a relative pulse duty cycle and/or a pulse energy, may be in a range of ±0.2 or ±0.1 times the mean value of this pulse parameter, rather than being constant.

### BRIEF DESCRIPTION OF THE DRAWINGS

Exemplary embodiments of the disclosure are shown in the figures and are described in more detail below. In the figures:

FIG. 1 shows a schematic structure of a device for laser material machining according to embodiments of the present disclosure;

FIG. 2 shows a schematic diagram of the pulse parameters;

FIG. 3A shows a graph of measured values of the breakthrough time as a function of the pulse frequency for different workpiece thicknesses;

FIG. 3B shows micrographs of a piercing process in a stainless steel sheet having 30 mm thickness at different pulse frequencies;

FIG. 4A shows a schematic diagram of a piercing process with a limit pulse frequency at a first point in time;

FIG. 4B shows a schematic diagram of the piercing process of FIG. 4A at a second point in time after a piercing stop has occurred;

FIG. 6 shows a schematic diagram of the radiated laser power or the radiated pulse sequence as a function of the piercing time during a method for piercing with stepwise decrease of the pulse frequency at a constant pulse on-time according to embodiments of the present disclosure;

FIGS. 7A to D show schematic diagrams of the relationship between pulse frequency and piercing depth during the piercing method of FIG. 6;

FIG. 8 shows a schematic diagram of the pulse frequency as a function of the piercing time during a method for piercing with stepwise decrease of pulse frequency bands according to embodiments of the present disclosure; and

FIG. 9 shows a schematic diagram of the pulse frequency as a function of the piercing time during a method for piercing with decrease of a line of best fit of the pulse frequency according to embodiments of the present disclosure.

### DETAILED DESCRIPTION OF THE INVENTION

Unless otherwise stated, the same reference symbols are used in the following for the same elements and elements with equivalent effect.

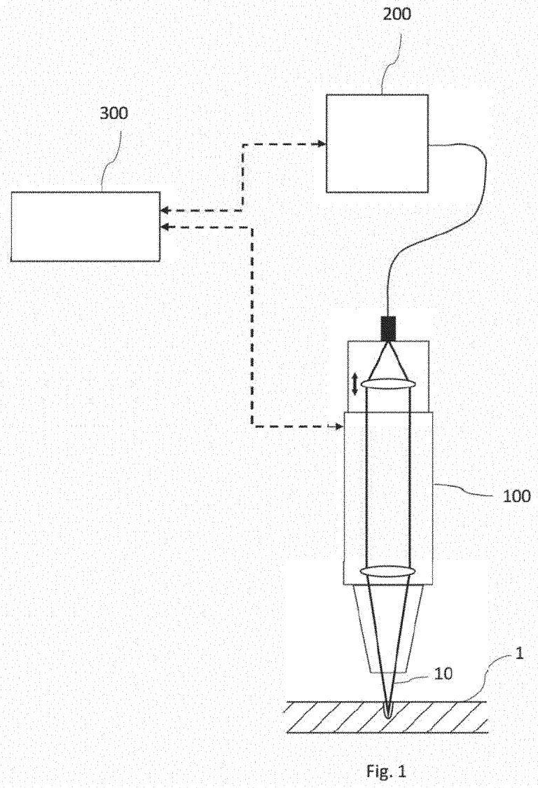

FIG. 1 shows a schematic diagram of a device for laser material machining according to embodiments of the present disclosure. The device for laser material machining may include a laser machining head 100, in particular a laser cutting head, for radiating a laser beam 10 onto a workpiece 1, a laser source 200 for generating the laser beam 10, and a control device 300. The control device 300 is set up or configured to control the device, in particular to control the device according to a method according to one of the embodiments described in this disclosure.

The laser source 200 emits a laser beam 10, also called a machining beam, which is guided and focused onto the workpiece 1 by machining optics. The machining optics and/or the laser source 200 are connected to the control device 300. In addition to the control function, the control device 300 may also have an evaluation and/or calculation function. The machining optics may have transmitting and/or reflecting optical elements for beam guidance and beam shaping. Furthermore, the device for laser material machining may include a gas supply for supplying a process gas into a machining zone on the workpiece 1.

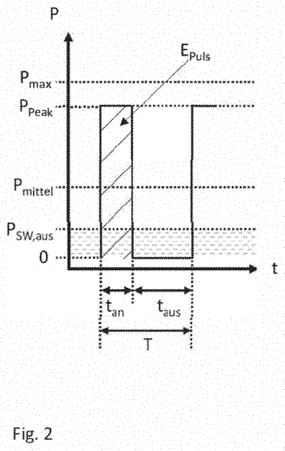

During piercing, the laser beam 10 is directed onto the workpiece 1 in a pulsed manner. A schematic overview of the pulse parameters is shown in FIG. 2. The pulse period or pulse period T results from the pulse on-time tₐₙ and the pulse off-time tₐᵤₛ:

T=tₐₙ+tₐᵤₛ

The pulse on-time tₐₙ denotes the time period of the laser pulse during which energy is radiated onto the workpiece 1. Correspondingly, the pulse off-time tₐᵤₛ denotes the time span during which no or virtually no energy is radiated onto the workpiece 1. The reciprocal of the pulse period T is called the pulse frequency: f=1/T. The pulse frequency is therefore a function of both the pulse on-time and the pulse off-time. The relationship between pulse on-time and pulse period is referred to as the relative pulse duty cycle R: R=tₐₙ/T. The pulse peak power Pₚₑₐₖ may correspond to the maximum laser power provided by the laser source 200, hereinafter maximum laser power, Pₘₐₓ. The radiated energy during a pulse, i.e. the so-called pulse energy, is calculated from the product of pulse peak power and pulse on-time:

E_{Puls}=Pₚₑₐₖ×tₐₙ.

Accordingly, the radiated mean pulse power is calculated from the product of the relative duty cycle and the pulse peak power or from the product of the pulse peak power and the pulse on-time and pulse frequency:

Pₘᵢₜₜₑₗ=Pₚₑₐₖ×R=Pₚₑₐₖ×tₐₙ×f=Pₚₑₐₖ×(1−tₐᵤₛ/(tₐₙ+tₐᵤₛ)).

For the purposes of the present disclosure, not only the time of the pulse period during which no energy is radiated may be regarded as a pulse off-time, but also a time of the pulse period during which the radiated energy or the radiated power remains below a threshold value. Such a threshold value for the radiated power is shown in FIG. 2 as P_{SW,aus}. This means that, when the current power radiated onto the workpiece is below said threshold value P_{SW,aus}, there is a pulse off-time. The threshold value may be, for example, 30% of the maximum laser power (P_{SW,aus}=0.3×Pₘₐₓ) or 20% of the maximum laser power or even 10%× of the maximum laser power.

According to the present disclosure, the control device 300 is configured to control an energy input into the machining zone or onto the workpiece 1 as a function of one or more of the following process parameters and boundary conditions: material thickness or workpiece thickness, material of the workpiece, current piercing time, current piercing depth, process gas type, process gas pressure, focal position, imaging ratio of the optical system, focus diameter and nozzle distance to the top of the workpiece. Based on at least one of the parameters mentioned, the energy input may be controlled by the pulse on-time (tₐₙ), pulse off-time (tₐᵤₛ) and/or the pulse peak power (Pₚₑₐₖ) as a function of the current piercing time or piercing depth. By knowing the causal relationships in the process zone, it is possible to adjust the process parameters in a targeted manner and thus to increase process efficiency.

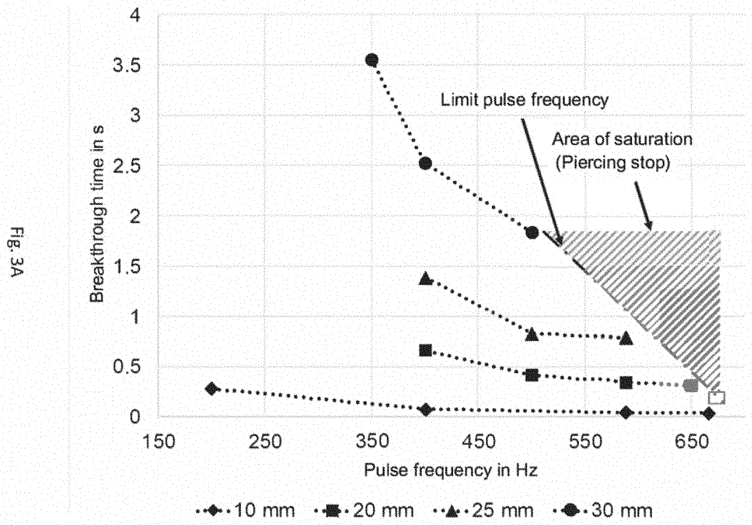

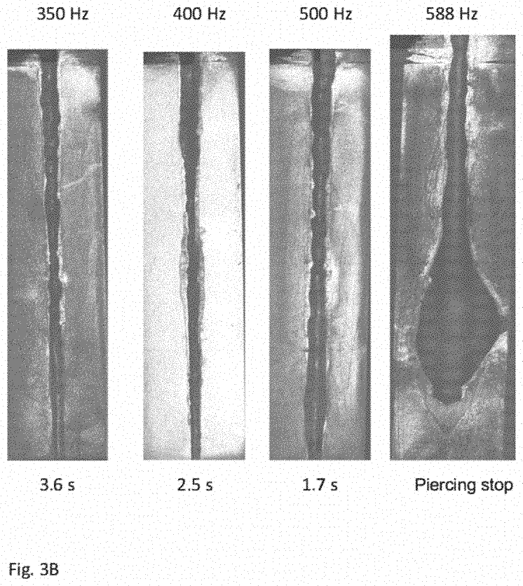

As a rule, the piercing rate (change in piercing depth over time) decreases with increasing piercing depth, and the breakthrough time, i.e. the time from the first radiation of the laser beam onto the workpiece until the breakthrough, increases with increasing piercing depth s. FIG. 3A shows the breakthrough time (in seconds) as a function of a selected pulse frequency (in Hertz) for different material thicknesses or workpiece thicknesses (in millimeters). Here, the pulse frequency is constant during the entire piercing process. With decreasing pulse frequency, the breakthrough time increases disproportionately. The cause is, inter alia, the increasing resolidification of the melt on the wall of the piercing hole. As a result, the piercing rate decreases and the process efficiency drops. Furthermore, an area of saturation, in which depth subtraction is stopped, is hatched, and a so-called limit pulse frequency is drawn as a function of the material thickness. The limit pulse frequency describes a pulse frequency threshold above which reliable piercing is no longer possible under the given process parameters and boundary conditions. The limit pulse frequency shifts towards lower pulse frequencies as the material thickness increases.

FIG. 3B shows micrographs of piercing breakthroughs in a workpiece of 30 mm thickness made of stainless steel at a peak pulse power of 6 kW (cf. top curve in FIG. 3A). At a pulse frequency of 350 Hz (constant), the breakthrough time is 3.6 s (first image from the left in FIG. 3B), at a pulse frequency of 400 Hz (constant), the breakthrough time is 2.5 s (second image from the left in FIG. 3B), and at a pulse frequency of 500 Hz (constant), the breakthrough time is 1.7 s (third image from the left in FIG. 3B). At a pulse frequency of 588 Hz (constant), there is a piercing stop (no breakthrough, to the right in FIG. 3B).

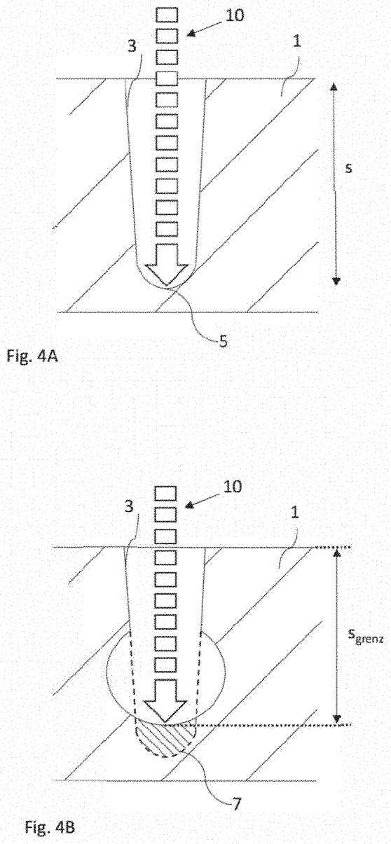

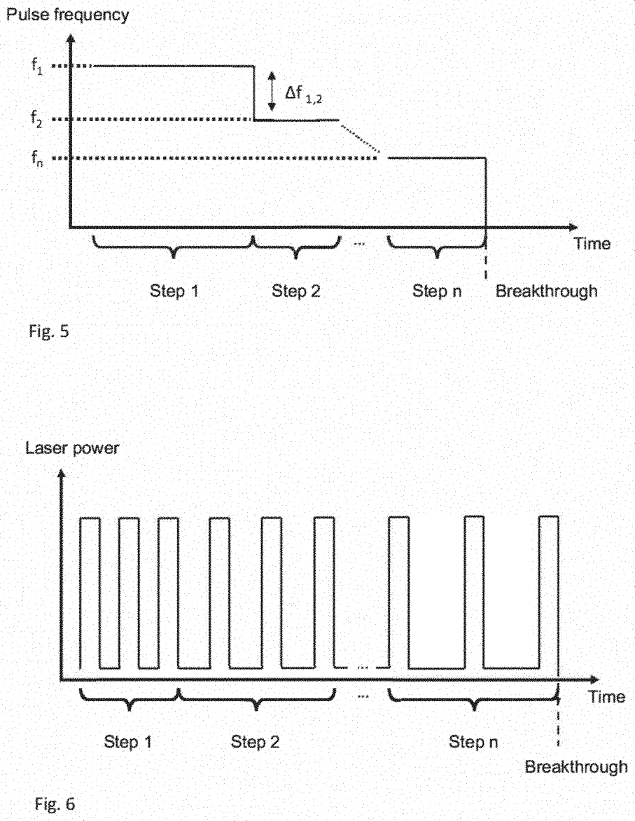

In FIGS. 4A and 4B, the piercing hole 3 is shown schematically for two different points in time when piercing at a limit pulse frequency. From a certain piercing depth s, the time between the individual pulses (pulse off-time) is too short or the pulse frequency is too high to expel the molten material from the piercing hole 3 in sufficient quantity, so that a piercing stop occurs. A further reason for the piercing stop is the decreasing introduced energy of the laser beam 10 at the piercing base 5 with increasing piercing depth s and the increasing distance that the melted material has to travel before exiting the piercing hole 3 (see FIG. 4A). As the piercing depth increases, the radiated energy also heats the sides of the piercing hole 3 so that cave-like melting may occur. In the case of high material thicknesses, e.g. greater than 20 mm, the piercing process may go into saturation (see FIG. 4B), at which point the piercing rate approaches 0 (piercing stop), when the pulse frequency is arbitrarily large or greater than a respective limit pulse frequency. The residual melt in the piercing hole 3 and the subsequent pulses lead to an ever increasing heating of the machining zone from pulse to pulse. This results in heat accumulation in the puncture hole (pulse-to-pulse mechanism), which leads to a specific area of material transversely to the direction of piercing being melted and filling the piercing base 5 with material again and again. The previously achieved piercing depth s decreases and, as a result, a limit piercing depth s_{grenz} is reached (cf. FIG. 4B and FIG. 3B on the right). A reliable breakthrough is not possible (piercing stop in piercing direction).

According to the invention, in order to avoid a piercing stop while shortening the breakthrough time, the mean pulse power radiated onto the workpiece during piercing is reduced. In this way, the piercing rate can be maximized along the piercing depth and, at the same time, a breakthrough can be ensured. Several embodiments of the method for piercing according to the present disclosure are described below.

In the following, according to embodiments, a method for piercing a workpiece and a device for laser material machining with a control device configured to carry out this method are provided. According to embodiments, the mean pulse power radiated is reduced by lowering the pulse frequency during piercing. However, the present invention is not limited thereto. Alternatively, the mean pulse power radiated may be reduced, for example, by lengthening the pulse off-time and/or shortening the pulse on-time and/or reducing a relative duty cycle.

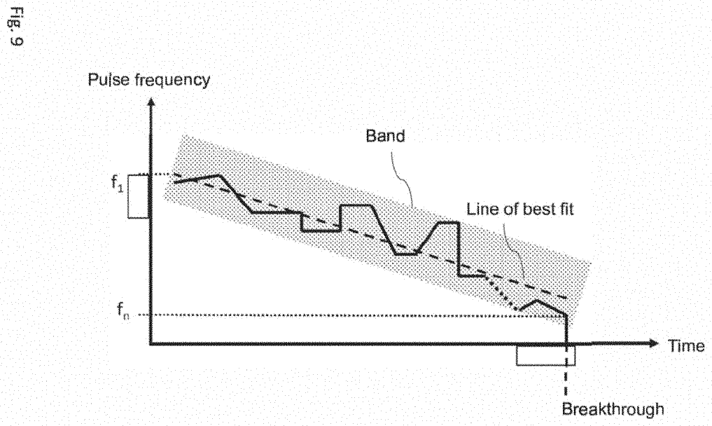

In the embodiment illustrated in FIG. 5, the pulse frequency is reduced in stages or steps or discretely. For example, the pulse frequency is lowered at least once, preferably at least twice, during the breakthrough time. In this case, the method for piercing may include at least a first piercing step, step 1, at a first pulse frequency f₁ and a second piercing step, step 2, at a second pulse frequency f₂, the first pulse frequency f₁ being greater than the second pulse frequency f₂. The first piercing step, step 1, therefore takes place at the start of piercing and the second piercing step, step 2, takes place after the first piercing step, step 1. However, the method may also include any number, e.g. n, piercing steps, the pulse frequency of each piercing step being lower than that of a preceding piercing step. The pulse frequency may be constant during a piercing step. Alternatively, as described below for FIG. 9, the pulse frequency during a piercing step may be in a range of 80% and 120%, preferably 90% and 110%, of the mean pulse frequency fₙ of this nth piercing step (i.e. fₙ±0.2×fₙ or fₙ±0.1×fn). The change in pulse frequency between the piercing steps, i.e. Δf_{1,2}, may be the same or different. Preferably a first change, i.e. Δf_{1,2}, is greater than a second change, i.e. Δf_{2,3}. Likewise, the duration of the individual piercing steps may be the same or different. A duration of the first piercing step is preferably the longest.

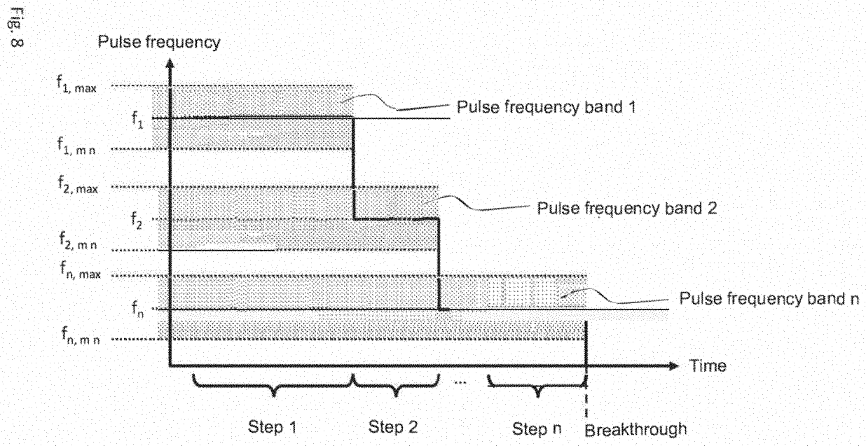

As an alternative to a stepwise or discrete decrease, the pulse frequency may be reduced in any combination of discrete and continuous decreases during the breakthrough time (see also FIG. 8).

With regard to FIG. 5, at least one change or decrease in the pulse frequency (f<f₁) is described. The pulse frequency at the start of piercing or at the beginning of the breakthrough time f₁ and/or the pulse frequencies f₂ to fₙ of the subsequent piercing steps may be adjusted as a function of the thickness of the workpiece and/or the current piercing time and/or the current piercing depth.

In one embodiment, piercing at variable pulse frequency may occur with two changes in pulse frequency. The pulse frequency at the start of piercing and/or in the first piercing step is preferably greater than or equal to the limit pulse frequency for this workpiece, which may depend on the workpiece thickness and the workpiece material.

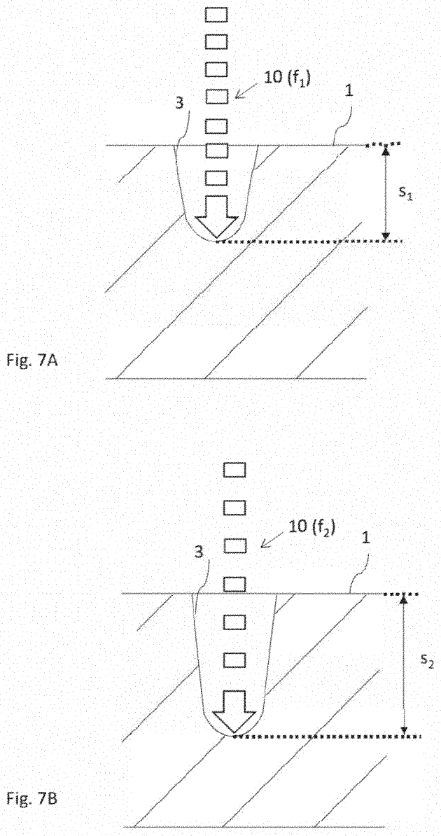

A further embodiment is shown schematically in FIG. 6. As in FIG. 5, the pulse frequency is reduced in n piercing steps until breakthrough. In addition, in the embodiment shown in FIG. 6, the pulse on-time tₐₙ remains constant or quasi-constant throughout the entire piercing process. In the latter case, the pulse on-time may deviate by ±20% or ±10% of the mean pulse on-time during the breakthrough time. In other words, a quasi-constant pulse on-time may be within a band from 0.8×tₐₙ to 1.2×tₐₙ or from 0.9×tₐₙ to 1.1×tₐₙ.

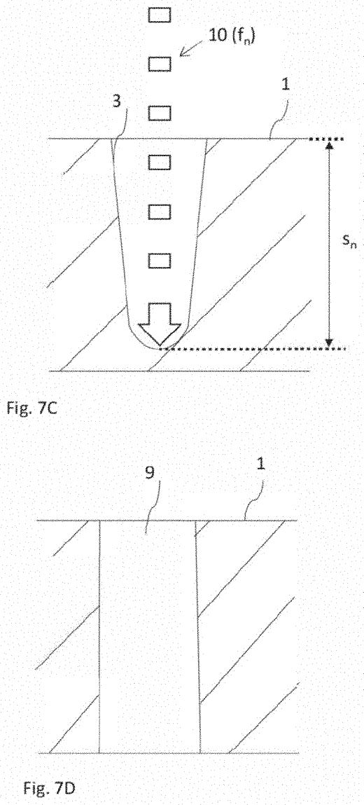

The value for the pulse on-time tₐₙ is preferably selected as a function of the workpiece thickness. In this case, the mean pulse power or the pulse frequency is reduced by increasing the pulse off-time tₐᵤₛ, for example as a function of the piercing time (FIG. 6) or the piercing depth (FIG. 7). This may ensure that, as the piercing depth increases, the melt has sufficient time between the pulses to be expelled from the piercing hole, for example by the process gas blown in.

In the embodiment shown in FIG. 6, instead of a constant pulse on-time, the radiated pulse energy E_{Puls}, i.e. the product of pulse peak power and pulse on-time, may be kept constant, while the other pulse parameters may be selected to be the same as in the embodiment shown in FIG. 6. Optionally, the pulse energy may be set to a material- and thickness-dependent minimum value.

In a further embodiment illustrated in FIG. 7, the workpiece thickness is at least 20 mm and the pulse peak power is at least 4 kW. The method for piercing includes at least three piercing steps with different pulse frequencies. The piercing process is started at a first pulse frequency that is greater than or equal to a limit pulse frequency that is dependent on the workpiece thickness (FIG. 7A: f_{grenz}≤f₁). This may correspond to step 1 of FIG. 5. After a predetermined piercing time and/or piercing depth, the pulse frequency is reduced to a second pulse frequency f₂, which is lower than the first pulse frequency or the limit pulse frequency (FIG. 7B: f₂<f₁ or f₂<f_{grenz}≤f₁). This may correspond to step 2 of FIG. 5. After a further predetermined piercing time and/or piercing depth, the pulse frequency is reduced to a third pulse frequency f₃, which is lower than the second pulse frequency (FIG. 7C: f₃<f₂) and maintained until breakthrough 9 (cf. 7D). In the example of piercing a workpiece made of stainless steel of 30 mm thickness at a peak pulse power of 6 kW from FIG. 3, the breakthrough time could be reduced by more than 50%, namely from 1.7 s at a constant pulse frequency of 500 Hz to 0.8 s, by this method. The pulse frequency was changed twice during piercing: from a first pulse frequency at the start of piercing of f₁=588 Hz to a second pulse frequency of f₂=400 Hz and then to a third pulse frequency of f₃=350 Hz. The first pulse frequency f₁ of 588 Hz was higher than the limit pulse frequency (cf. FIG. 3A). This resulted in an optimized piercing process in terms of a short piercing time and reliable breakthrough.

As mentioned above, the mean pulse power or the pulse frequency does not have to be decreased monotonically or strictly monotonically. Instead, the mean pulse power or the pulse frequency may be decreased in steps or stages, wherein the mean pulse power or the pulse frequency may move within a power band or pulse frequency band in each step. That is, during each step the mean pulse power or the pulse frequency lies within a band with a specified minimum value and a specified maximum value. The power band may be defined by a deviation of ±20%, in particular ±10%, of the average mean pulse power during the piercing step, step n. Similarly, the pulse frequency band may be defined by a deviation of ±20%, in particular ±10%, of the average pulse frequency fₙ during the piercing step, step n. FIG. 8 shows examples of pulse frequency bands in which the pulse frequency may vary during the individual steps 1, . . . n. The pulse frequency bands shift to smaller values with each step. For example, the pulse frequency bands may decrease in steps or stages. In FIG. 8, the pulse frequency bands are defined as follows: f_{1,min}=0.8×f₁ (or 0.9×f₁); f_{1,max}=1.2×f₁ (or 1.1×f₁); f_{2,min}=0.8×f₂ (or 0.9×f₂); f_{2,max}=1.2×f₂ (or 1.1×f₂); f_{n,min}=0.8×fₙ (or 0.9×fₙ); and f_{n,max}=1.2×fₙ (or 1.1×fₙ). In other words, slight increases in the pulse frequency may be neglected as long as the pulse frequency is lowered on average over time until breakthrough. If the mean pulse power is reduced by changing another pulse parameter, for example by lengthening the pulse off-time, this change may also be made in steps, wherein said pulse parameter, in each step, may lie in a band of ±20%, in particular ±10%, of the mean value of said pulse parameter in this step.

Likewise, the mean pulse power or the pulse frequency may be reduced continuously or quasi-continuously. It may be sufficient that the mean pulse power or the pulse frequency vary in a band which, on average, decreases over time (cf. FIG. 9). That is, the mean pulse power or the pulse frequency decrease over time. In other words, the mean pulse power or the pulse frequency may be considered to be decreased when a corresponding line of best fit or regression (dashed line in FIG. 9) has a negative gradient during the breakthrough time, i.e. from the start of piercing to breakthrough. This is because a very brief increase in the mean pulse power or the pulse frequency can be neglected for the piercing method according to this disclosure. When the mean pulse power is decreased by changing another pulse parameter, for example by lengthening the pulse off-time, this change may also be continuous or quasi-continuous, as long as a line of best fit or regression for this pulse parameter has a negative slope during the breakthrough time.

According to the embodiments of this disclosure, a method and a device for piercing a workpiece by means of a laser beam are provided, which minimize a breakthrough time or maximize a piercing rate while ensuring reliable piercing and preventing a piercing stop.

1. A method for piercing a workpiece by a laser beam, comprising:
radiating a pulsed laser beam onto a workpiece to form a piercing breakthrough;
wherein a radiated mean pulse power of the pulsed laser beam is reduced during piercing.

2. The method according to claim 1, wherein the radiated mean pulse power is reduced discretely and/or in steps and/or continuously.

3. The method according to claim 1, wherein a line of best fit of the radiated mean pulse power has a negative slope during piercing.

4. The method according to claim 1, wherein the radiated mean pulse power and/or a pulse frequency is reduced in steps and, during each step, lies within a band with a predetermined minimum value and a predetermined maximum value.

5. The method according to claim 1, wherein the radiated mean pulse power is reduced by at least one of the following changes in pulse parameters of the pulsed laser beam: lengthening a pulse off-time, shortening a pulse on-time, reducing a pulse frequency, and reducing a relative pulse duty cycle.

6. The method according to claim 1, wherein the radiated mean pulse power is reduced by lengthening a pulse off-time and keeping a pulse peak power and/or a pulse on-time and/or a pulse energy constant during piercing.

7. The method according to claim 1, wherein a first pulse frequency in a first piercing step at a start of piercing is greater than or equal to a predetermined limit pulse frequency.

8. The method according to claim 1, wherein the radiated mean pulse power is reduced in at least two steps, wherein a first pulse frequency in a first piercing step is greater than or equal to a predetermined limit pulse frequency and a second pulse frequency in a second piercing step is less than the first pulse frequency or than the limit pulse frequency.

9. The method according to claim 7, wherein the predetermined limit pulse frequency is based on a thickness and/or a material of the workpiece, and/or wherein the predetermined limit pulse frequency specifies a pulse frequency from which on a piercing stop occurs.

10. The method according to claim 1, wherein at least one of pulse parameters of the pulsed laser beam, selected from the group comprising a mean pulse power radiated, a pulse off-time, a pulse on-time, a pulse frequency, a relative pulse duty cycle and a pulse peak power, is adjusted based on a material and/or a thickness of a workpiece and/or on a current piercing time and/or on a current piercing depth.

11. The method according to claim 1, wherein a pulse off-time and/or a pulse on-time of the pulsed laser beam is in a range between 0.01 ms and 100 ms or between 0.1 ms and 10 ms.

12. The method according to claim 1, wherein a pulse frequency of the pulsed laser beam is in a range between 200 Hz and 3000 Hz or between 400 Hz and 2000 Hz.

13. The method according to claim 1, wherein, when piercing a workpiece with a thickness of more than 20 mm, the radiated mean pulse power is changed in at least two steps.

14. The method according to claim 1, wherein the radiated mean pulse power is controlled as a function of at least one of the following parameters: thickness of the workpiece, material of the workpiece, current piercing time, current piercing depth, type of process gas, process gas pressure, imaging ratio of an optical system of a laser machining head, focal position, focal diameter, intensity distribution of the laser beam, nozzle type, nozzle diameter, and nozzle distance from the workpiece.

15. The method according to claim 1, wherein a metallic workpiece is pierced.

16. A method of laser cutting, comprising:
a method for piercing according to claim 1; and
cutting by means of the laser beam starting from the formed piercing breakthrough.

17. A device for laser material machining of a workpiece, comprising:
a laser source for generating a laser beam;
a laser machining head for radiating the laser beam onto said workpiece; and
a control device configured to control said device to perform the method for piercing according to claim 1.

18. The method according to claim 15, wherein the metallic workpiece is a metallic sheet.
